(19) United States
(12) Patent Application Publication
(10) Pub. No.: US 2002/0170727 A1
(43) Pub. Date: Nov. 21, 2002

(54) Protective cover

(76) Inventors: John E. Holland, Bailey, NC (US); Connie W. Holland, Bailey, NC (US)

Correspondence Address: Lewis S. Rowell, Rhodes & Mason, P.L.L.C., 1600 First Union Tower, 300 North Greene Street, Greensboro, NC, 27282, US

(21) Appl. No.: 09/860,423

(22) Filed: May 18, 2001

(51) Int. Cl. H02G 15/22

(52) U.S. Cl. 174/19

(57) ABSTRACT

A protective cover for cables and hoses used in environments such as airports and the like in which the cables and hoses are dragged around and subjected to abrasion, chemicals, and weather extremes. The protective cover includes a sleeve surrounding the cable or hose, the sleeve having open ends and formed of a fabric made substantially of high strength yarn.

### FIELD OF THE INVENTION

The present invention relates to the field of protective coverings, and, more particularly to a protective cover for hoses and cables of the type that are periodically moved and dragged across abrasive surfaces such as concrete and asphalt, in environments such as airports and the like.

### BACKGROUND OF THE INVENTION

As the industrial complex in the United States and abroad has grown over the last century, so has the demand for reliable means for transporting electricity, communications signals, and fluid media. Early constructions of power lines and pipeline systems proliferated, but they have not been without attendant unreliability and lack of service durability. For example, overhead insulated power lines have been susceptible to wear and abrasion from trees. Sandpaper-type wrappings have been attempted to counter these effects. Windings of fiberglass and rubber have been applied to protect underwater-type cables and conduits from rocks, coral, and seawater. Braided metal and plastic sheathings have been developed to protect certain types of cables and hoses; however, these have been bulky and too rigid for many applications. Narrow bands of rigid materials have been developed for reducing the friction between a hose and an abrasive surface by placing the bands at regular intervals along the length of a hose; however, exposure of the unbanded surface area of these hoses to the elements and to chemicals continues to be problematic.

In certain industries, such as the airline industry, fuel hoses and electrical cables, encased only in rubber or other soft insulating materials, must be pulled and dragged across abrasive surfaces, such as concrete and asphalt, to service aircraft. In many airports, the hose and/or cable must be moved over an abrasive service many times during a single day. The surface may be wet or have gasoline or chemicals thereon. The wear on conventional hoses causes frequent replacement to be necessary. Substantial annual costs to replace worn cables and hoses have thus been common. Further, constant exposure to the elements and to ultraviolet radiation accelerates the interval between replacements. Since these cables and hoses are produced to meet commercial federal industry safety standards, costs of $15 per foot, or more, are not uncommon. Yet, there has not heretofore been an effective, practical, solution to this problem.

### SUMMARY OF THE INVENTION

The present invention is directed to a simple, yet effective, abrasion-resistant protective system for hoses, cables, and other conduits of the type used in high abrasion applications such as the airline industry.

In its simplest construction, the present invention comprises a protective covering, or sleeve, having open ends to be fitted over substantially the entire surface area of a cable or hose. The protective cover is constructed from a woven fabric formed primarily from high-strength (high performance) yarns. As used herein, “high-strength yarns” refers to the entire family of yarns that have a tensile modulus equal to or greater than 150 grams/denier and a tenacity equal to or greater than 7 grams/denier. Such yarns may be formed from long chain polyethylene fibers (known as SPECTRA®), aramids such as KEVLAR® (Dupont), liquid crystal polymers such as VECTRAN® (Hoechst Celanese), or combinations thereof. The preferred yarn for the fabric is available from suppliers, such as Allied Signal, under the tradename SPECTRA®. Fabrics woven or knitted from selected one of these yarns have a high level of tear-resistance, abrasion-resistance, cut-and-stab resistance, ultraviolet radiation resistance, and resistance to chemicals and low temperatures. These characteristics improve both the strength and durability of the fabric. In addition, fabric so formed is only about one third the weight of conventional fabrics like vinyl-coated nylons and polyesters.

In the preferred embodiment, the protective cover is constructed as a sleeve that may be easily and quickly installed over an existing cable or hose, and just as quickly and easily removed or replaced. Accordingly, the protective cover is initially formed a length of abrasion-resistant fabric with attaching elements along opposed edges. The length of fabric is dimensioned so that the width of the fabric sheet is slightly greater than the circumference of the cable or hose with which the sleeve is intended for use, and the length of the fabric sheet approximates the total length of cable or hose to be protected. The fabric is a woven single layer with a preferred weight of between about 5 and 8 ounces per square yard; however, the cover is not weight limited. Thus, the warp and fill yarns are of a weight in the range of 400 to 1,000 denier with warp and fill picks of 30 to 36 yarns per inch each. The range of parameters of this single fabric layer is designed to provide a fabric that is extremely lightweight and flexible, while also providing sufficient strength and long-lasting durability to withstand the use and environment to which a cable and hose cover is exposed in the referenced applications.

While not required for abrasion-resistance, a lightweight coating or lamination is provided on the outer surface of the protective cover to enhance the penetration resistance of the fabric by fluids, chemicals, and particulate matter where such additional protection is desired. It has been found that a thermoplastic film of polyethylene or ethylene vinyl acetate suitably bonds to fabrics formed from high-strength yarns, including SPECTRA®.

Means for fastening the length of fabric and holding it in place are affixed along the opposed longitudinal edges of the fabric length. An important advantage of this aspect is that the sleeve so formed may be easily installed or removed (in the case of replacement) from cables or hoses without the need for disconnecting or disassembling the hoses or cables from their installed applications. Thus, the protective cover of the present invention may be easily fitted over a hose or electrical cable that is presently in service without having to disrupt operations by uncoupling the hose or cable or removing the fittings therefrom. The fasteners preferred for this application are hook and loop strips that allow the sleeve to be completely closed along its entire length. Hook and loop fastening strips are most commonly available under the trademark VELCRO®. To ensure extra holding capability, either multiple strips may be used or wider strips may be affixed to the edges of the length of fabric. Alternatively, other fasteners such as snaps, ties, and the like could be used.

Another embodiment of the present invention is in the form of short lengths of protective coverlets constructed from the fabric described above. In applications where the entire cable or hose does not have to be covered, as in the case where abrasion alone is the primary concern, a series of spaced apart narrow coverlets, or protective bands, may be wrapped around the cable or hose at selected intervals and fastened as described above.

A further embodiment of the present invention is directed to an abrasion-resistant cable or hose construction in which a permanently affixed outer protective layer, formed substantially from high strength yarns. The outer layer may be either adhered to the hose or cable with adhesives or cement that are resistant to chemical attack, or the fabric may be imbedded or impregnated into the outer surface of the cable or hose during the manufacture thereof.

These and other aspects of the present invention will become apparent to those skilled in the art after a reading of the following description of the preferred embodiments when considered in conjunction with the drawings. It should be understood that both the foregoing general description and the following detailed description are exemplary and explanatory only and are not restrictive of the invention as claimed.

### BRIEF DESCRIPTION OF THE DRAWINGS

FIG. 1 is a perspective view of a protective cover form from a fabric of high-performance yarns;

FIG. 2 is a perspective view of a protective cover with reclosable fasteners affixed along opposed longitudinal edges;

FIG. 3 is a perspective view of the protective cover of FIG. 1 or 2 with an optional end hood;

FIG. 4 is a perspective view of spaced-apart protective coverlets constructed in accordance with the present invention;

FIG. 5A is an end view of an abrasion-resistant cable having an outer layer of fabric formed from high-performance yarns; and

FIG. 5B is an end view of an abrasion-resistant hose having an outer layer of fabric formed from high-performance yarns.

### DETAILED DESCRIPTION OF THE PREFERRED EMBODIMENTS

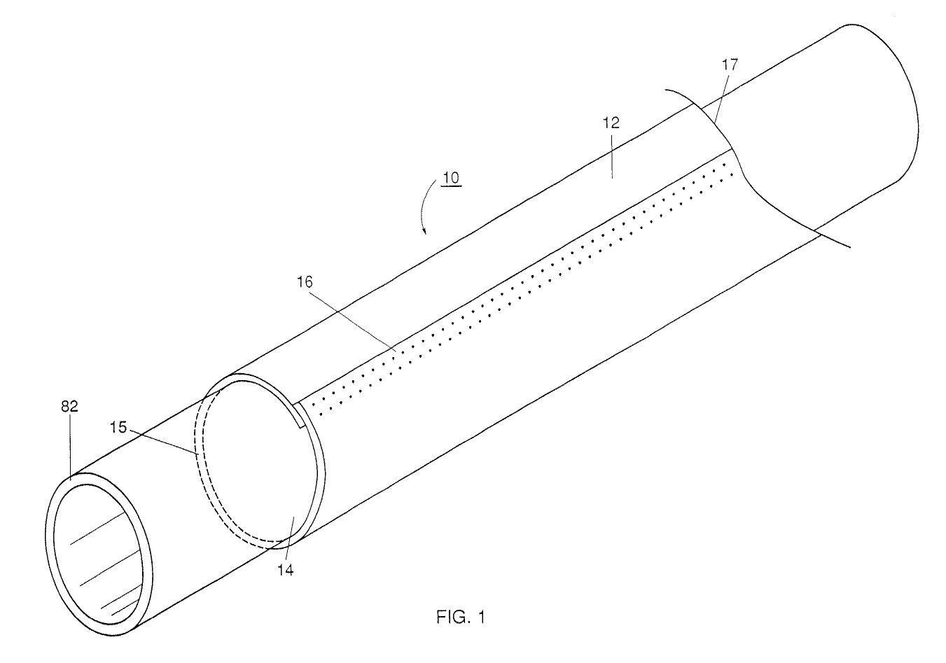

As shown in FIG. 1, one aspect of the present invention is directed to a protective cover for cables and hoses of the type used in commercial applications, such as the airline industry. Shown generally as 10 in FIG. 1, in its simplest form the protective cover comprises a sleeve having an outer surface 12, an inner surface 14, and open ends 15, 17. Protective cover 10 is formed from a singular length of woven fabric with a single layer that is sewn together along longitudinal edges to form a seam 16.

The fabric used to form the abrasion-resistant and cut-resistant protective cover is woven from high-strength yarns. As used herein, “high strength yarns” means yarns formed from fibers having a tensile modulus equal to or greater than 150 grams/denier and a tenacity equal to or greater than 7 grams/denier. In the preferred embodiment, the yarns used to form the woven sheet are formed from long chain polyethylene fibers available from suppliers, such as Allied Signal, under the trademark SPECTRA®. Other acceptable yarns may be formed from aramids, such as KEVLAR® or liquid crystal polymers, such as VECTRAN®. Fabric so formed from SPECTRA®, for example, has a high level of tear-resistance, abrasion-resistance, cut-and-puncture-resistance, resistance to low temperatures, and resistance to chemicals such as aviation fuel and oils. It also retains its durability after prolonged exposure to ultraviolet radiation. Additionally, the fabric is only about ⅓ the weight of conventional fabrics like nylon and polyester.

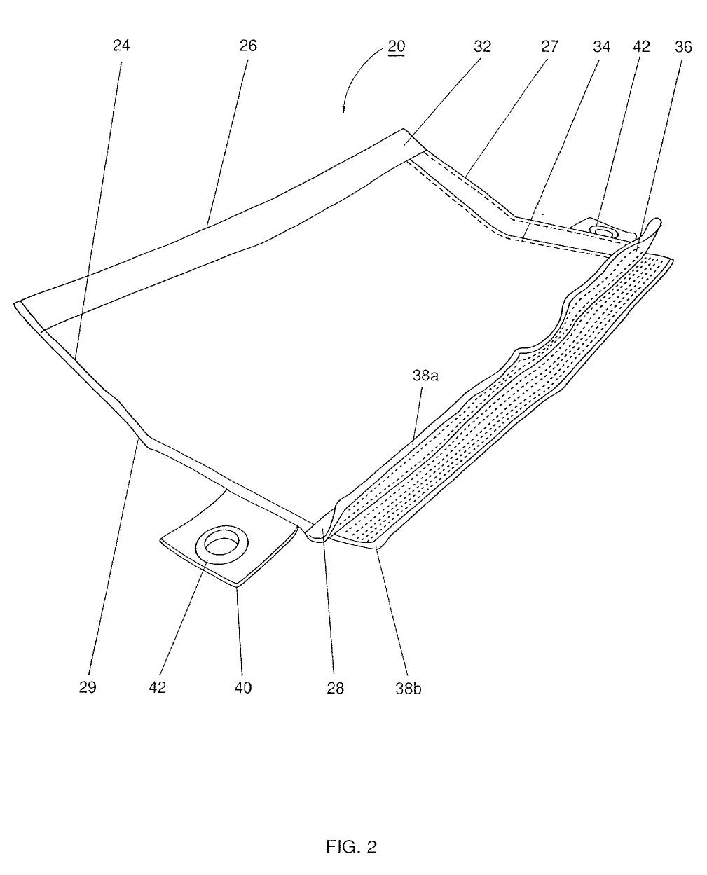

As shown in FIG. 2, in the preferred embodiment, protective cover 20 is constructed as a wrap. The wrap is formed as an elongated sheet having an outer surface 22 and an inner surface 24, opposed longitudinal edges 26, 28, and opposed ends 27, 29. The woven fabric sheet is a single layer with a preferred weight between about 5 and 8 ounces per square yard. Hems are sewn into the edges 26, 28 and ends 27, 29 to prevent raveling thereof. The warp and fill yarns are desirably in the range of between about 400 and 1,000 denier and the warp and fill picks are in the range of about 30 to 36 yarns per inch each. However, the range of possible deniers and picks per inch are not limited thereto. As those skilled in the art will appreciate, a lighter or heavier fabric having a more open or more closed weave may be selected to construct a protective cover for a specialized application. Likewise, the fabric need not be formed from a single yarn. For instance, in applications in which protective cover 20 may be subjected to tensile stresses in the horizontal axis that could create “creep,” or stretching, the fabric may be formed with a blend of yarns comprising up to 30% KEVLAR® with the SPECTRA® construction. That is, blended yarns formed from up to about 30% of such high-strength fibers, or in the alternative, up to about 30% of the yarn ends being formed entirely from high-strength filaments, would provide an acceptable combination. This blend of SPECTRA® and KEVLAR® has been found quite effective in reducing creep. Additionally, where cost is a key factor and susceptibility to wear less severe, small percentages of more conventional yarns such as polyester and nylon may be substituted. As would be expected, the resistance characteristics described hereinabove will be reduced in such constructions. As those skilled in the art will also appreciate, the fabric of the present invention may also be knitted or formed in other ways that are conventional and known in the textile arts.

To provide an additional level of wear resistance and to further enhance fluid or particulate penetration resistance of the fabric construction, a lightweight coating, or lamination 30, is applied on the outer surface 22. It has been found that a thermoplastic film of polyethylene or ethylene vinyl acetate suitably bonds to fabrics formed from high-performance yarns, including SPECTRA®. The process for applying lamination 30 is described in detail in co-pending application Ser. No. 08/957,431, incorporated by reference herein. While not required, lamination may also be applied to inner surface 24 as an additional measure of penetration resistance.

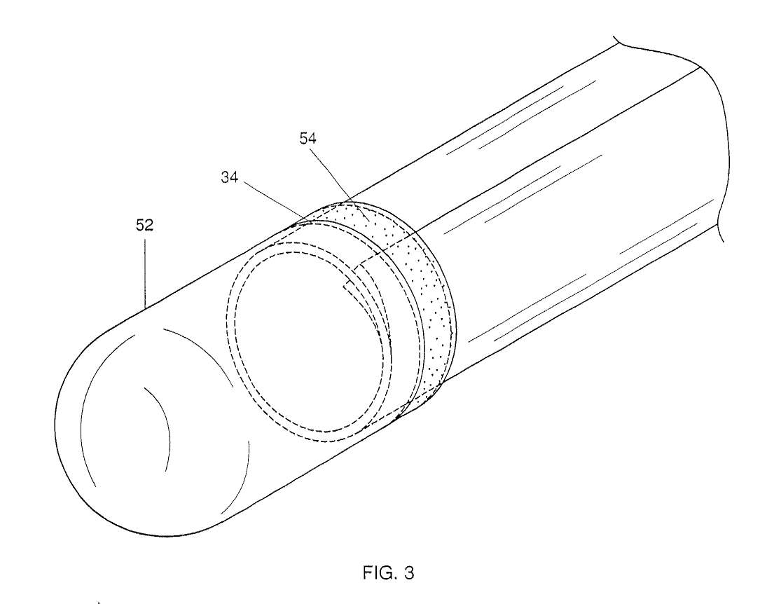

To enable protective cover 20 to be fitted and secured around a cable or hose, fasteners are provided along the opposed longitudinal edges 26, 28. As best seen in FIG. 2, narrow strips of hook 32 and loop 36 fasteners are affixed to opposed edges26 and 28. These fastening strips are designed to engage one another along the entire surface area of contact between the strips, and are commercially available and widely known under the tradename VELCRO®. In the preferred embodiment, hook strips 32 are affixed to both sides of the woven sheet. Likewise, loop strips 36 are affixed to separate narrow flaps 38a, 38b that are joined at a seam along edge 28. This doubles the fastening capability of single strips of hook and loop material. As shown in FIG. 3, when protective cover 20 is fitted around a cable or hose, flaps 38a, 38b cover the strips 32 of hook material. Thus, the protective cover 20 may be fitted easily over an installed cable or hose without the need to disconnect or disassemble the cable or hose from its installed condition. Alternatively, and as those skilled in the art will appreciate, other types of fasteners or fastening material may substitute for VELCRO®. These include, but are not limited to adhesives, bands, snaps, buttons, zippers, etc.

Once protective cover 20 has been fitted over the cable or hose to be protected, the ends of the protective cover are further secured to the hose, cable, or accessories affixed thereto. Tabs 40 are formed at opposite ends 27, 29 of the elongated fabric sheet. Grommets 42 of brass or other materials having suitable strength are affixed to tabs 40. In this way, the user may choose to pass a cord, tie, chain, or other length of material through each of the grommets 42 to further secure protective cover 20 to the ends of the hose or cable or to an attached structure.

As an accessory to protective cover 20, a separate protective hood 52 is provided. As shown in FIG. 3, hood 52 is formed of the same material as cover 20 and is desirably formed from a single piece of material; however, it may be formed from multiple pieces that are sewn together along multiple seams. Hood 52 is intended to protect the exposed ends of cables or hoses when they are not in use to prevent damage to those exposed ends and to prevent infiltration by contaminants. Referring again to FIG. 2, hood 52 may be secured to cover 20 with VELCRO® material in a manner similar to the fasteners described hereinabove. Hood strips 34 may be affixed to either or both ends of the elongated sheet. Likewise, a loop strip 54 may be affixed around the inside periphery of hood 52. Alternatively, hood 52 may be affixed by other means known in the art or simply formed to be snugly fitted over the exposed end with elastic bands or the like.

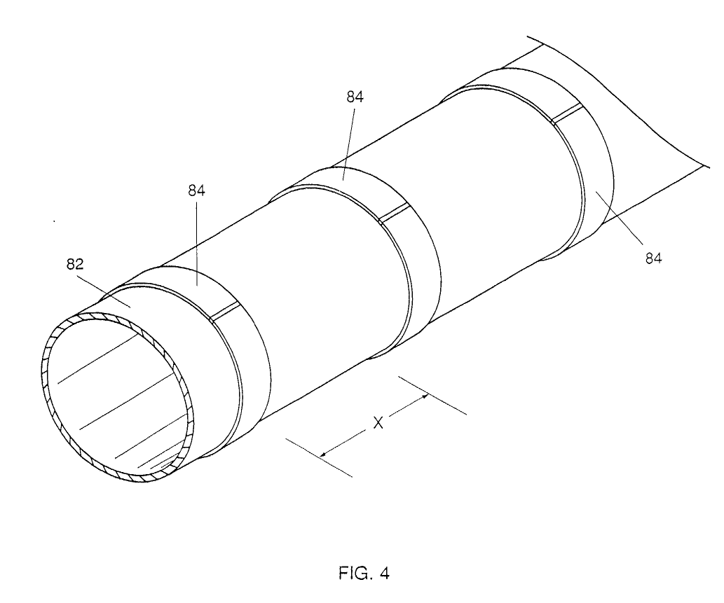

As shown in FIG. 4, another aspect of the present invention is to provide protective coverlets 84, or bands, that may be wrapped around hoses or cables 82 at spaced-apart intervals. Such coverlets 84 would be most appropriate for applications where exposure to chemicals, weather, and ultraviolet radiation are not a concern. Depending upon the degree of protection against abrasion that is desired, the distance between coverlets, shown as ‘X’, may be shorter or longer. Coverlets 84 also offer the user the option of placing them at critical abrasion points based on wear history, etc. Coverlets 84 are formed in the same manner and from the same material as the elongated sheet in FIG. 2.

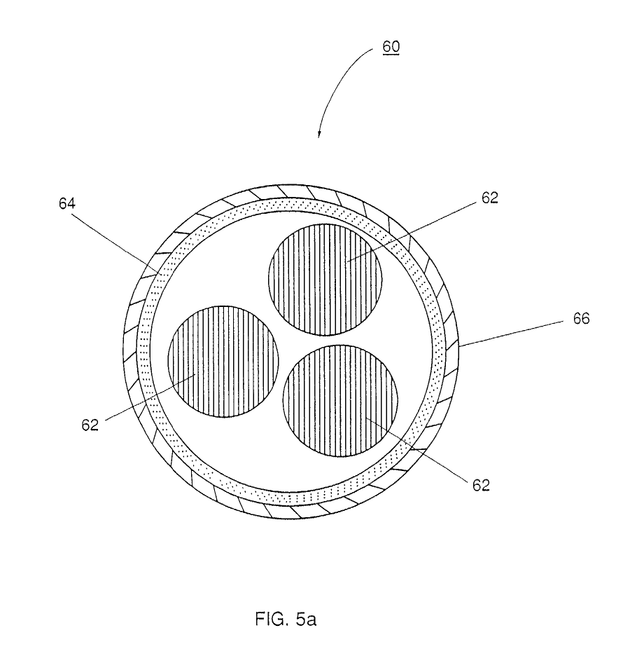

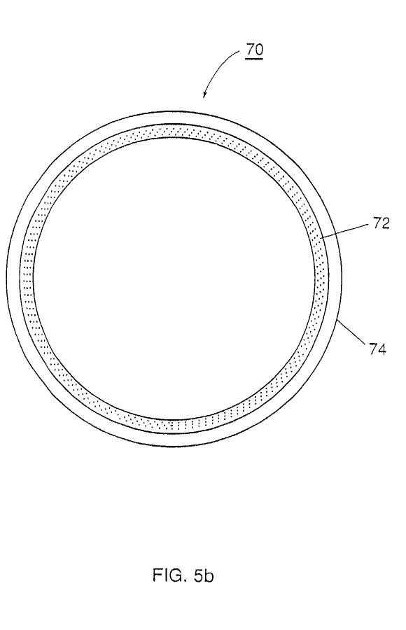

A further aspect of the present invention is to provide an abrasion-resistant electrical cable 60 or fuel hose 70, having a protective layer permanently affixed thereto. As shown in FIG. 5A, at least one length of conductive material 62 such as copper or the like is encased by an insulating layer 64 such as rubber or insulating plastic. So formed, this is simply a conventional electrical cable well known in the art and widely used commercially without any further modifications thereof However, for applications where such a cable is subjected to abrasive surfaces, an outer protective layer 66 formed from the woven fabric described hereinabove is permanently affixed to the intermediate insulating layer 64. The entire surface are of cable 60 is thus covered with the abrasion-resistant material. Outer layer 66 maybe cemented or glued with commercial-grade adhesives known in the art. Alternatively, outer layer 66 may be pressed or impregnated into the outer surface of layer 64 using techniques well known to those in the art. Similarly, fuel hose 70 is formed from a substantially impermeable resilient material 72, such as rubber, resulting in a hollow core. The outer layer 74 of abrasion-resistant material may be affixed atop layer 72 in the same fashion that it is affixed to cable 60. Thus, in applications where users require more permanently formed abrasion-resistant cables or hose, those constructed according to the present invention provide the needed solution.

Although the present invention has been described with a preferred embodiment, it is to be understood that modifications and variations may be utilized without departing from the spirit and scope of the invention, as those skilled in the art will readily understand. Such modifications and variations are considered to be within the purview and scope of the appended claims and their equivalents.

We claim:

1. A protective cover for cables or hoses used in environments such as airports and the like in which the cables and hoses are subjected to abrasion, chemicals, and/or weather extremes, said protective cover comprising a sleeve surrounding said cable or hose, said sleeve having open ends and formed of a fabric made substantially of high strength yarn.

2. The protective cover of claim 1 wherein said fabric is formed from at least 70 percent high-strength yarns.

3. The protective cover of claim 1 wherein said fabric has a weight of between about 5 and 8 ounces per square yard.

4. The protective cover of claim 1 wherein said fabric is resistant to petroleum-based products.

5. The protective cover of claim 1 wherein said high strength yarn is selected from the group consisting of long chain extended polyethylenes, high strength aramids, liquid crystal polymers, and combinations thereof.

6. The protective cover of claim 5 wherein said high strength yarns are about 400 to 1000 denier.

7. The protective cover of claim 6 wherein said fabric has a warp and fill density of between about 30 and 36 ends per inch.

8. The protective cover of claim 1 wherein said sleeve is formed as an elongated sheet having opposed longitudinal edges, said opposed longitudinal edges including means releasably attaching said opposed longitudinal edges together around the length of said cable or hose.

9. The protection cover of claim 8 wherein said means for fastening said opposed longitudinal edges comprises hook and loop material.

10. The protective cover of claim 1 wherein said sleeve is formed as a plurality of bands, each band comprising a short length of said fabric, said bands being spaced apart along the length of a cable or hose.

11. The protective cover of claim 10 wherein each of said bands is formed as a short length of fabric having opposed longitudinal edges, said opposed longitudinal edges including means for fastening said opposed longitudinal edges together around the length of said cable or hose.

12. The protection cover of claim 11 wherein said means for fastening said opposed longitudinal edges comprises hook and loop material.

13. The protective cover of claim 1 further including a hood formed of the same fabric as said sleeve and fastened to at least one end of said sleeve for protecting an exposed end of said cable or hose.

14. An abrasion-resistant cable or hose system, comprising:
(a) a cable or hose of the type that must be periodically moved or dragged across abrasive services; and
(b) a protective sleeve surrounding said cable or hose and formed from a fabric made substantially of high performance yarn, having open ends, wherein said sleeve protects said cable or hose from abrasion and wear thereof.

15. The system of claim 14 wherein said fabric is formed from at least 70 percent high-strength yarns.

16. The system of claim 14 wherein said fabric has a weight of between about 5 and 8 ounces per square yard.

17. The system of claim 14 wherein said fabric is resistant to petroleum-based products.

18. The system of claim 14 wherein said high strength yarn is selected from the group consisting of long chain polyethylenes, high strength aramids, liquid crystal polymers, and combinations thereof.

19. The system of claim 18 wherein said high strength yarns are about 400 to 1000 denier.

20. The system of claim 19 wherein said fabric has a warp and fill density of between about 30 and 36 ends per inch.

21. The system of claim 14 wherein said sleeve is formed as an elongated sheet having opposed longitudinal edges, said opposed longitudinal edges including means for releasably attaching said opposed longitudinal edges together around the length of said cable or hose.

22. The system of claim 21 further including means for securing said open ends of the sleeve to said cable or hose.

23. The system of claim 14 wherein said sleeve is formed as a plurality of bands, each band comprising a short length of said fabric, said bands being spaced apart along the length of a cable or hose.

24. The system of claim 14 wherein each of said bands is formed as a short length of fabric having opposed longitudinal edges, said opposed longitudinal edges including means for fastening said opposed longitudinal edges together around the length of said cable or hose.

25. The system of claim 24 wherein said means for fastening said opposed longitudinal edges comprises hook and loop material.

26. The system of claim 14 further including a hood formed of the same fabric as said sleeve and fastened to at least one end of said sleeve for protecting an exposed end of said cable or hose.

27. An abrasion-resistant cable of the type that must be periodically moved or dragged across abrasive services comprising an outer protective layer formed substantially from high performance yarns.

28. An abrasion-resistant hose of the type that must be periodically moved or dragged across abrasive surfaces and comprising a tubular wall formed of substantially impermeable resilient material forming a hollow core, and an outer protective layer affixed to said tubular wall, said outer layer formed substantially from a fabric of high performance yarn.
